(19) United States
(12) Patent Application Publication
(10) Pub. No.: US 2007/0220364 A1
(43) Pub. Date: Sep. 20, 2007

(54) Method for capturing a display frame of a computer crashing

(75) Inventor: Yung-Fu Li, Jungli City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/647,212

(22) Filed: Dec. 29, 2006

(30) Foreign Application Priority Data
Mar. 16, 2006 (TW) 095109053

(51) Int. Cl. G06F 11/00

(52) U.S. Cl. 714/45

(57) ABSTRACT

A method for capturing a display frame of a computer crashing. When the computer crashes, the display frame of the computer crashing is captured and saved. Thus, users can analyze the reason for causing the computer crashing later.

This application claims the benefit of Taiwan application Serial No. 95109053, filed Mar. 16, 2006, the subject matter of which is incorporated herein by reference.

### BACKGROUND OF THE INVENTION

1. Field of the Invention

The invention relates in general to an operation method for a server, and more particularly to a method of capturing and saving a frame of a server crashing.

2. Description of the Related Art

In the operation system software, such as the window operation system (Windows) for a computer, when the executed software crashes, Windows displays the crashing information on a screen (i.e., a so-called blue screen) in a text mode, or sends out the system information (i.e., the system information to be displayed on the blue screen) from a serial port in the text mode. However, the crash caused by the basic input output system (BIOS) or the crash phenomenon, such as that caused by hardware, cannot be recorded by Windows, and the user cannot obtain the information before crash. In other words, the user cannot get the actual reason for causing the crash.

In addition, if the computer has to be always on according to the operating requirement, for example, a server has to be always on in order to provide the associated service of a network ticket ordering system, this computer (e.g., server) utilizes a watchdog timer of a baseboard management controller (BMC) to monitor whether the server crashes. When the server crashes, the BMC reboots the server so as to provide the associated service continuously. Although the server has been rebooted, the user cannot analyze the reason for causing the crash if he or she cannot get the system information displayed on the blue screen or Windows cannot record the information before crash. Consequently, the crashing phenomenon may continuously occur such that the server cannot work normally. In addition, the system manager has to spend a lot of time to sit in front of the server and wait for the random crash phenomenon so as to snapshot the information before crash. Thus, it is an important subject of the invention to provide a method of recording the information effectively before the computer crashes.

### SUMMARY OF THE INVENTION

It is therefore an object of the invention to provide a method of capturing and saving a display frame of a computer crashing such that the relational operator can analyze the reason for causing the crash.

The invention achieves the above-identified object by providing a method of capturing a display frame of a computer crashing of a computer. The computer includes a baseboard management controller (BMC) and a signal capturing unit. The signal capturing unit is, for example, a capturing unit, which is referred to as a Remote KVM, for capturing a remote keyboard signal, a remote video signal and a mouse signal. The method includes the following steps. First, a timer is set to count a predetermined time and the timer is started after the computer is turned on. Then, if a basic input output system (BIOS) or software in the operation system cannot reset the timer within the predetermined time, the baseboard management controller judges that the computer crashes, and the signal capturing unit is enabled to capture the display frame of the computer crashing. Thereafter, the display frame is saved into a memory of the computer, or transferred to the remote computer through a network and saved to a storage device of the remote computer. Finally, the baseboard management controller reboots the computer.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 is a schematic illustration showing the computer architecture according to a preferred embodiment of the invention; and

FIG. 2 is a flow chart showing a method of capturing a display frame of a computer crashing according to the preferred embodiment of the invention.

### DETAILED DESCRIPTION OF THE INVENTION

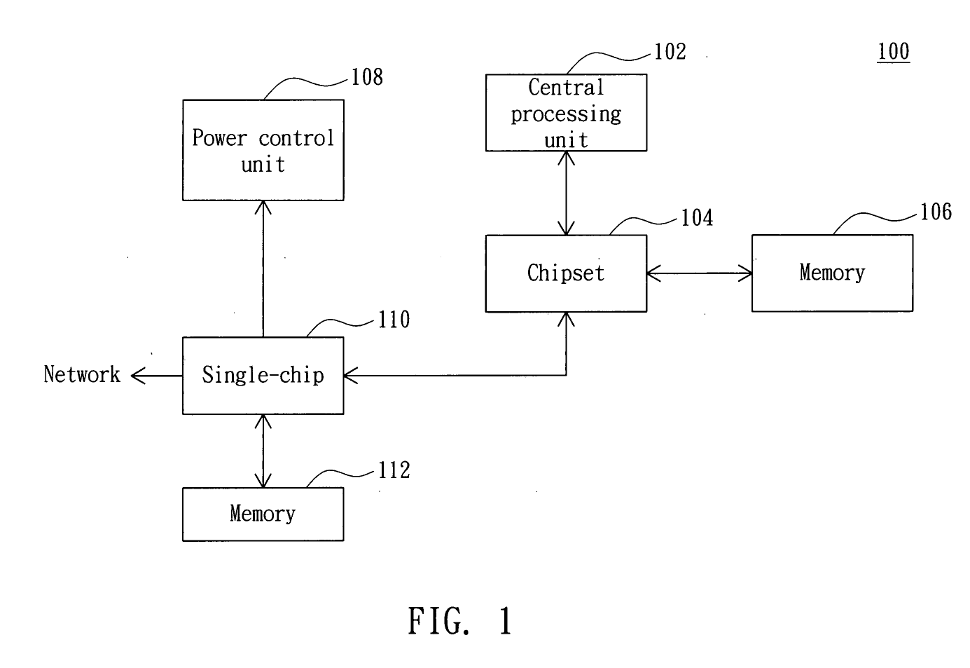

FIG. 1 is a schematic illustration showing the computer architecture according to a preferred embodiment of the invention. Referring to FIG. 1, the computer 100 has a central processing unit 102, a chipset 104, a memory 106, a power control unit 108 and a single-chip 110. The chipset 104 may be, for example, a south bridge chip or a north bridge chip, which is bridged between the central processing unit 102 and the memory 106. The memory 106 may be, for example, a dynamic random access memory. The power control unit 108 provides the power for the computer 100.

The single-chip 110 may include, for example, a baseboard management controller (BMC) and a signal capturing unit. The signal capturing unit is, for example, a capturing unit, which is referred to as a Remote KVM, for capturing a remote keyboard signal, a remote video signal and a mouse signal. The signal capturing unit is connected to a display interface of the computer 100 and can get a display frame of the computer 100. The BMC, the signal capturing unit and the display interface are not shown in the drawing. The computer 100 can transfer its display frame to a remote computer through the signal capturing unit such that a remote user can use the remote computer, through the network, to control the operation of the computer 100. In other words, the single-chip 110 captures the display frame of the computer 100 through the signal capturing unit.

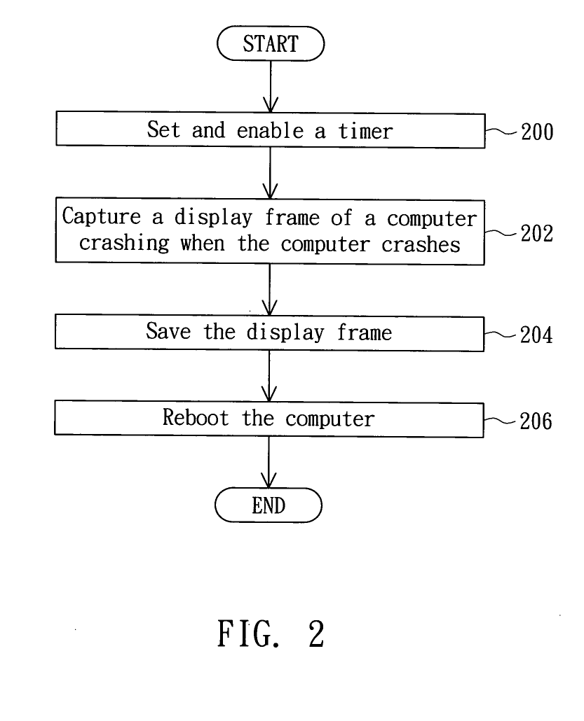

FIG. 2 is a flow chart showing a method of capturing a display frame of a computer crashing according to the preferred embodiment of the invention. First, a timer (e.g., a watchdog timer) set in the baseboard management controller is set to count a predetermined time (e.g., 30 seconds) after the computer 100 is turned on, and the timer is started, as shown in step 200. Then, if the basic input output system (BIOS) or the software in the operation system cannot reset this timer within this predetermined time, the baseboard management controller judges that the computer crashes, and the signal capturing unit captures the display frame of the computer crashing, as shown in step 202. In general, when the computer 100 works normally, the BIOS or the software in the operation system resets the timer within this predetermined time. However, when the BIOS or the software in the operation system has not reset this timer yet after this predetermined time, the baseboard management controller judges that the computer 100 crashes. At this time, the signal capturing unit captures the display frame when the computer 100 crashes. Thereafter, the display frame captured by the signal capturing unit is saved into a memory (e.g., a flash memory) 112 of the computer 100, or is transmitted through the network to the remote computer and saved into a storage device of the remote computer, as shown in step 204. Finally, the baseboard management controller reboots the computer 100, as shown in step 206.

Consequently, the display frame before crash can be preserved according to the signal capturing unit and the baseboard management controller in the single-chip 110 of this embodiment regardless of the crash reason of the computer 100, and then the computer 100 may be rebooted such that the relational operator can access the crash frame saved in the memory 112 of the computer 100 and thus analyze the reason for crashing later. The type of the display frame being saved upon crash is not particularly limited in this invention. For example, the display frame captured by the signal capturing unit may be saved in the flash memory, and further may be saved in a storage device (e.g., a hard drive or an optical disk) of another computer through the network. This embodiment enables the relational operator to get the display frame before the computer crashes in a more effective manner. Thus, the operator does not have to sit in front of the computer to wait for the crash phenomenon and to snapshot the information before crash.

In addition, it is to be noted that the computer 100 of this embodiment is not particularly limited, and may be the typical desktop computer, a notebook computer, a barebone system or a server. In addition, the display interface of the computer 100 may be independent of the single-chip 110 or integrated with the single-chip 110. Furthermore, this embodiment does not intend to restrict the type of the display interface, and the manner of integrating with or separating from other chips in the computer 100. It is accepted as long as the signal capturing unit of the single-chip 110 can be connected to the display interface.

As mentioned hereinabove, the invention provides a method of capturing and saving a display frame before a computer crashes such that the relational operator can analyze the reason for causing the crash later.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of capturing a display frame of a computer crashing of a computer, comprising the steps of:
setting a timer to count a predetermined time and starting the timer;
capturing the display frame of the computer crashing if the timer cannot be reset within the predetermined time;
saving the display frame; and
rebooting the computer.

2. The method according to claim 1, wherein the step of saving the display frame comprises saving the display frame into a memory of the computer.

3. The method according to claim 2, wherein the memory is a flash memory.

4. The method according to claim 1, wherein the step of saving the display frame comprises:
transmitting the display frame to a remote computer through a network, and saving the display frame to a storage device of the remote computer.

5. The method according to claim 1, wherein the timer is set in a baseboard management controller of the computer.

6. The method according to claim 1, wherein the step of capturing the display frame of the computer crashing is achieved by a signal capturing unit in the computer.

7. The method according to claim 1, wherein the step of rebooting the computer is achieved by a baseboard management controller of the computer.
